(19) United States
(12) Patent Application Publication
(10) Pub. No.: US 2024/0233400 A1
(43) Pub. Date: Jul. 11, 2024

(54) METHOD OF IDENTIFYING TRAFFIC SIGNS, SYSTEM, AND VEHICLE

(71) Applicant: HON HAI PRECISION INDUSTRY CO., LTD., New Taipei (TW)

(72) Inventors: TSUNG-WEI LIU, New Taipei (TW); CHIN-PIN KUO, New Taipei (TW)

(21) Appl. No.: 18/398,529

(22) Filed: Dec. 28, 2023

(30) Foreign Application Priority Data
Jan. 9, 2023 (CN) 202310028039.3

(51) Int. Cl. G06V 20/58; B60W 30/14; G06V 20/56

(52) U.S. Cl. CPC G06V 20/582; B60W 30/143; G06V 20/588; B60W 2420/403; B60W 2552/53; B60W 2555/60

(57) ABSTRACT

A method of identifying traffic signs is provided. The method obtains an image of a travel in front of vehicle during a travel of the vehicle. Where the image of the travel comprises one or more traffic lanes and one or more traffic signs. The method processes the image of the travel to obtain an image of a first lane where the vehicle is in. The method obtains an image of a traffic sign corresponding to the image of the first lane from the image of the travel according to the image of the first lane. The method outputs one or more control signals to a driving system of the vehicle according to content of the image of the traffic sign corresponding to the image of the first lane. A related vehicle and a non-transitory storage medium are provided.

### FIELD

The subject matter herein generally relates to an intelligent transportation technology, and particularly to a method of identifying traffic signs, a system, and a vehicle.

### BACKGROUND

Nowadays, a device, such as an electronic navigation system or a driver assistance system can capture image during as a vehicle travels. The device can identify one or more traffic signs in the image, for example identify content of the one or more traffic signs such as a speed limit sign, a direction sign of a travel of a lane, a traffic light, and so on. The device can further prompt or prewarn a driver according to the identified content.

However, a road may include a number of traffic lanes and a number of traffic signs are erected above the road. Different traffic sings may have functions of traffic management indication to different traffic lanes. Thus, different traffic signs may interfere with each other. The device may not accurately detect the traffic sign correspond to a current travel state of the vehicle.

### SUMMARY

An embodiment of the present application provides a method of identifying traffic signs, a vehicle, and a storage medium which can accurately detect a traffic sign suitable for a current travel state of the vehicle from the traffic signs in a captured image, reduce an interference of complex traffic signs to a driving of the vehicle, thus an accuracy prompt to a driver or an accuracy control of a travel of the vehicle according to the traffic signs can be achieved.

In a first aspect, an embodiment of the present application provides a method of identifying traffic signs. The method obtains an image of a travel in front of vehicle when the vehicle is moving forward. Where the image of the travel comprises one or more traffic lanes and one or more traffic signs. The method processes the image of the travel to obtain an image of a first lane where the vehicle is in. The method obtains an image of a traffic sign corresponding to the image of the first lane from the image of the travel according to the image of the first lane. The method outputs one or more control signals to a driving system of the vehicle according to content of the image of the traffic sign corresponding to the image of the first lane.

According to some embodiments of the present application, the method establishes a relationship between the traffic lanes and the traffic signs by identifying the traffic lanes and the traffic signs in the image of the travel, and obtains the image of the traffic sign corresponding to the image of the first lane according to the relationship established between the traffic lanes and the traffic signs.

According to some embodiments of the present application, the method determines an image of one or more second lanes corresponding to the one or more traffic lanes in the image of the travel by identifying the traffic lanes in the image of the travel, and determines an image of one or more sign targets corresponding to the one or more traffic signs by identifying the traffic signs in the image of the travel. The method further establishes the relationship between the traffic lanes and the traffic signs according to a relative position between each of the second lanes and each of the sign targets, the image of the second lanes, and the image of the sign targets.

According to some embodiments of the present application, the method determines an image of one or more second lanes corresponding to the one or more traffic lanes in the image of the travel by identifying the traffic lanes in the image of the travel; where each of the second lanes corresponds to one traffic lane. The method determines an image of one or more sign targets corresponding to the one or more traffic signs by identifying the traffic signs in the image of the travel. Where each of the sign targets corresponds to one traffic sign. The method inputs the image of the second lanes and the image of the sign targets into a preset model for associating the traffic lanes with the traffic signs, to establish the relationship between the traffic lanes and the traffic signs if the image of the second lanes and the image of the sign targets do not meet a preset matching condition.

According to some embodiments of the present application, the image of the second lanes and the image of the sign targets meet the preset matching condition if a first number of the second lanes is the same as a second number of the sign targets.

According to some embodiments of the present application, the method identifies a position of a main lane and positions of a number of lane lines in the image of the travel. The method determines image of the first lane according to a relative position between the position of the main lane and the positions of each lane line.

According to some embodiments of the present application, the method performs a perspective processing on the image of the travel, to obtain the image of the travel in a bird's eye perspective.

In a second aspect, an embodiment of the present application provides a vehicle. The vehicle includes a storage device and at least one processor. The storage device stores one or more programs, which when executed by the at least one processor, cause the at least one processor to obtain an image of a travel in front of vehicle when the vehicle is moving forward, where the image of the travel comprises one or more traffic lanes and one or more traffic signs, and process the image of the travel to obtain an image of a first lane where the vehicle is in. The vehicle further causes the at least one processor to obtain an image of a traffic sign corresponding to the image of the first lane from the image of the travel according to the image of the first lane, and output one or more control signals to a driving system of the vehicle according to content of the image of the traffic sign corresponding to the image of the first lane.

In a third aspect, an embodiment of the present application provides a non-transitory storage medium. The non-transitory storage medium stores a set of commands, when the commands being executed by at least one processor of a vehicle, causing the at least one processor to obtain an image of a travel in front of vehicle when the vehicle is moving forward, where the image of the travel comprises one or more traffic lanes and one or more traffic signs, and process the image of the travel to obtain an image of a first lane where the vehicle is in. The non-transitory storage medium further causes the at least one processor to obtain an image of a traffic sign corresponding to the image of the first lane from the image of the travel according to the image of the first lane, and output one or more control signals to a driving system of the vehicle according to content of the image of the traffic sign corresponding to the image of the first lane.

The disclosure can obtain the image of the first lane and the image of the traffic sign corresponding to the image of the first lane by identifying the traffic lanes and the traffic sign in the image of the travel after obtaining the image of the travel, and output the control signal to the driving system of the vehicle according to content of the image of the traffic sign corresponding to the image of the first lane. Thus, in a condition of an expansive and a complex traffic signs erected above the traffic road, the method can accurately detect the traffic sign suitable for the current travel state of the vehicle from the traffic signs. An interference of complex traffic signs to a driving of the vehicle is reduced, thus an accuracy prompt to a driver or an accuracy control of a travel of the vehicle according to the traffic signs can be achieved.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a flowchart of an embodiment of a method of identifying traffic signs.

FIG. 2 is a flowchart of an embodiment of a process of block S102 of the flowchart in FIG. 1.

FIG. 3 is a view of an embodiment of an image of a road according to a method of identifying traffic signs, where a position of a main lane is in a dotted box.

FIG. 4 is a flowchart of an embodiment of a process of block S103 of the flowchart in FIG. 1.

FIG. 5 is a view of an embodiment of an image of a travel according to a method of identifying traffic signs, where the road includes three traffic lanes, and a traffic sign plate is erected above each traffic lane.

FIG. 6 is a flowchart of an embodiment of a process of block S401 of the flowchart in FIG. 1.

FIG. 7 is a flowchart of another embodiment of a process of block S401 of the flowchart in FIG. 1.

FIG. 8 is a view of another embodiment of an image of a travel according to a method of identifying traffic signs, where the road includes three traffic lanes, and a traffic light is erected above the road.

FIG. 9 is a view of an embodiment of a system of identifying traffic signs according to the present disclosure.

FIG. 10 is a block diagram of an embodiment of a vehicle according to the present disclosure.

FIG. 11 is a block diagram of another embodiment of a vehicle according to the present disclosure.

### DETAILED DESCRIPTION

Objects, technical solutions and advantages of embodiments of the present application will be clearer from a clear and complete description of technical solutions of the present application in connection with the drawings. Apparently, the described embodiments are part, not all, of the embodiments of the present application.

In the following description, reference numerals, such as S101 and S102 . . . , of related steps do not indicate that the steps are necessarily performed in such an order. Where permitted, steps may be performed in a reversed order or at the same time. Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may Furthermore, the particular features, structures or characteristics may be combined in any suitable manner, as would be apparent to one of ordinary skill in the art from this disclosure, in one or more embodiments.

Unless otherwise defined, all technical and scientific terms used in this specification have a same meaning as those commonly understood by a person skilled in the art of this application. In case of inconsistency, a meaning specified in this specification or derived from content specified in this specification is used. In addition, terms used in this specification are merely intended to describe embodiments of this application, and are not intended to limit this application.

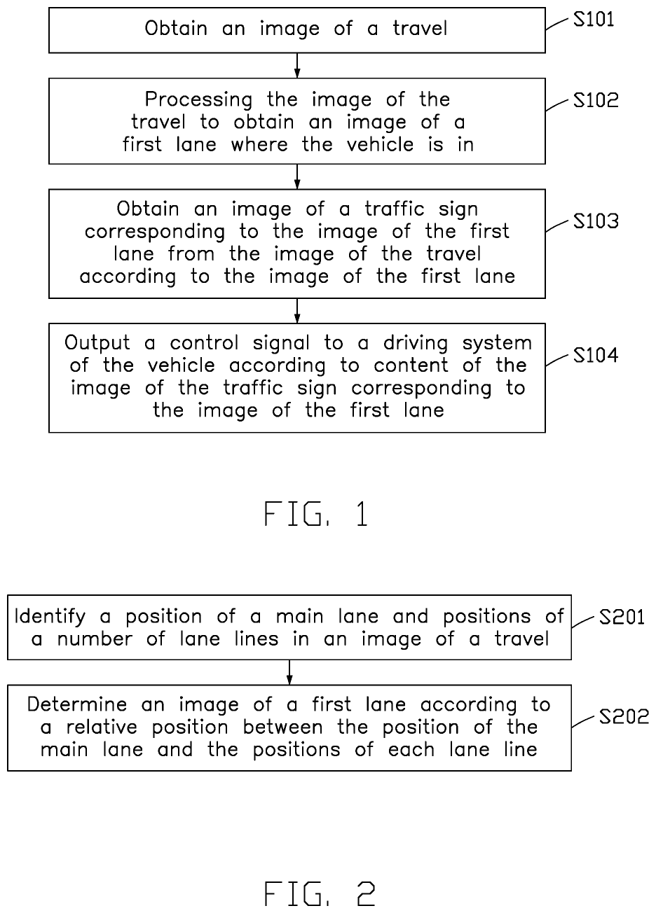

Referring to FIG. 1, a flowchart of an embodiment of a method of identifying traffic signs is shown. Furthermore, the illustrated order of blocks is illustrative only and the order of the blocks can change. Additional blocks can be added, or fewer blocks may be utilized, or the order of the blocks may be changed, without departing from this disclosure. The method includes:

S101, obtaining an image of a travel.

The image of the travel is an image in front of vehicle captured when the vehicle is moving forward. The image of the travel includes one or more traffic lanes and one or more traffic signs. Namely, there are at least one traffic lane and at least one traffic sign simultaneously in the image of the travel.

In the embodiment, each traffic sign is a sign erected on the road and each traffic sign has a function of a traffic management indication to the vehicles travelled on the one or more traffic lanes.

In some embodiments, the traffic signs include one or more of a group consisting of a speed limit sign, a direction sign of a travel of a lane, and the traffic light. Each speed limit sign indicates a speed limit of the traffic lane. Each direction sign of the travel of the lane indicates a direction of the travel of the traffic lane. Each traffic light indicates whether one or more traffic lanes can further travel onward.

In some embodiments, the image of the travel can be the image captured by a driving recorder, the disclosure is not limited herein.

S102, processing the image of the travel to obtain an image of a first lane where the vehicle is in.

In some embodiments, the first lane is the traffic lane where the vehicle is current in. The image of the travel includes all the traffic lanes of the road in the same direction. The method can recognize and extract a content related to each traffic lane from the image of the travel and analyze the content, to obtain the image of the traffic lane where the vehicle is current in, and record the first lane to be the traffic lane where the vehicle is current in.

In some embodiments, the first lane includes a lane index. The lane index is configured to distinguish different traffic lanes on the same road. For example, in the image of the travel, the lane index of the first lane is \textcircled{1}, thus the first lane is a first traffic lane arranged in a preset arrangement sequence on the road. For example, in the image of the travel, the lane index of the first lane is \textcircled{2}, thus the first lane is a second traffic lane arranged in a preset arrangement sequence on the road, and so on. In the embodiment, the preset arrangement sequence can be from left to right, the disclosure is not limited herein.

S103, obtaining an image of a traffic sign corresponding to the image of the first lane from the image of the travel according to the image of the first lane.

In some embodiments, the traffic sign corresponding to the first lane can have the function of the traffic management indication to the vehicle travelled on the first lane. When the vehicle travels on the first lane, the content of the image of the traffic sign should be noted.

S104, outputting a control signal to a driving system of the vehicle according to content of the image of the traffic sign corresponding to the image of the first lane.

The content of the image of the traffic sign corresponding to the image of the first lane can reflect the content of the traffic management indicated by the image of the traffic sign, and the control signal can be generated according to the content of the image of the traffic sign corresponding to the image of the first lane.

In the embodiment, the method can further recognize the content of the image of the traffic sign corresponding to the image of the first lane. A detail of recognizing the content of the image of the traffic sign corresponding to the image of the first lane can include, employing a semantic recognition to recognize the content of the image of the traffic sign corresponding to the image of the first lane, to obtain a corresponding content.

In some embodiments, if the image of the traffic sign is the image of the speed limit sign, the recognized content is a detail speed limit of the speed limit sign, and a corresponding control signal of a speed limit can be output to the driving system of the vehicle according to the detail speed limit. If the image of the traffic sign is the image of the direction sign of the travel of the lane, the recognized content is the direction of the travel of the vehicle indicated by the direction sign of the travel of the lane, and a corresponding control signal of the direction of the travel can be output to the driving system of the vehicle according to the direction of the travel. If the image of the traffic sign is the image of the traffic light, the recognized content is whether the vehicle can further travel onward indicated by the traffic light, and a corresponding passage control signal can be output to the driving system of the vehicle.

After one or more control signals corresponding to the image of the one or more traffic signs are output to the driving system of the vehicle, the driving system can make different decisions according to the one or more control signals. For example, the driving system can display prewarning information on a display device according to the control signal, to prompt a driver that one or more traffic signs are existed on the lane where the vehicle current travel on, and display at least one of a group consisting of a detail speed limit corresponding to the control signal of the speed limit, a detail direction of the travel corresponding to the control signal of the direction of the travel, and a traffic light state corresponding to the passage control signal.

In some embodiments, the driving system can control a travel state of the vehicle according to the control signals, for example adjusting a speed of a travel of the vehicle according to the control signal of the speed limit, controlling the vehicle to brake according to the passage control signal, and controlling the vehicle to change the lane where the vehicle is in according to the control signal of the direction of the travel.

It can be understood that, the speed limit sign, the direction sign of the travel of the lane, and the traffic light are some examples of the traffic signs, the traffic signs can includes, but is not limited to the speed limit sign, the direction sign of the travel of the lane, and the traffic light.

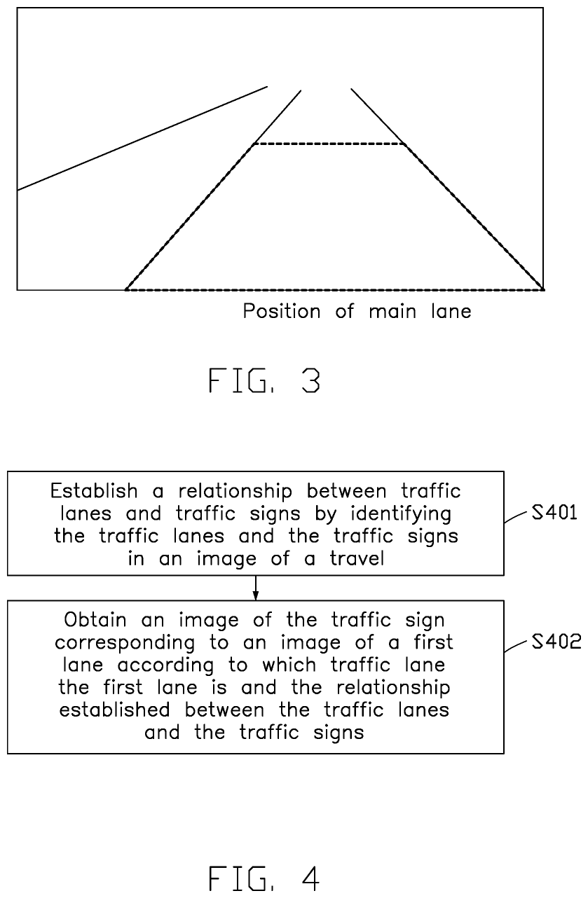

Referring to FIGS. 2-3, in some embodiments, S102, processing the image of the travel to obtain the first lane where the vehicle is in, includes:

S201, identifying a position of a main lane and positions of a number of lane lines in the image of the travel.

In some embodiments, the position of the main lane is a preset region in the image of the travel which represents the position in front of the vehicle. The lane lines are all the lane lines in the same direction existed in the road in the image of the travel. Each traffic lane should be positioned between two corresponding lane lines, thus the position of the main lane should be positioned between two lane lines. It can be understood that, the lane lines can be all the lane lines existed in the road in the image of the travel, the disclosure is not limited herein.

The method identifies the traffic lanes in the image of the travel via an algorithm for identifying the lane line, to obtain a number of lane lines. A region between each two adjacent lane lines is the position of the lane. Where, the position of the lane in a center of the image of the travel or having a largest size in the lanes in the image of the travel is the position of the main lane.

In some embodiments, before the S201, the S102 further includes:

Performing a perspective processing on the image of the travel, to obtain the image of the travel in a bird's eye perspective.

Where, the lane lines in the image of the travel in the bird's eye perspective are parallel with each other, the method can more accurately identify each lane line via the algorithm for identifying the lane line.

S202, determining the image of the first lane according to a relative position between the position of the main lane and the positions of each lane line.

Where, a traffic lane is formed between each two adjacent lane lines. When the number of the traffic lane is one in the image of the travel, the lane index of the lane on the position of the main lane in the image of the travel can be set to be 1, thus the image of the first lane can be determined.

In the image of the travel, when the number of the traffic lane is greater than one, the method determines the arrangement sequence of the position of the main lane in all the traffic lanes in the preset arrangement sequence according to a relative position between the position of the main lane and each lane line, to determine a lane index of the position of the main lane in the image of the travel, thus the image of the first lane can be determined.

For example, in the image of the travel, the position of the main lane is the first traffic lane in the arrangement sequence from left to right, thus the lane index of the lane on the position of the main lane in the image of the travel is set to be 1; in the image of the travel, the position of the main lane is the second traffic lane in the arrangement sequence from left to right, thus the lane index of the lane on the position of the main lane in the image of the travel is set to be 2, and so on.

Referring to FIGS. 4-5, in some embodiments, S103, obtaining an image of the traffic sign corresponding to the image of the first lane from the image of the travel according to the image of the first lane, includes:

S401, establishing a relationship between the traffic lanes and the traffic signs by identifying the traffic lanes and the traffic signs in the image of the travel.

Where, the method can identify the image of the travel via an algorithm for identifying the lane, to identify all the traffic lanes in the image of the travel. The method can identify the image of the travel via an algorithm for identifying the traffic sign, to identify all the traffic signs in the image of the travel.

Each traffic sign is related to at least one traffic lane. Each traffic sign has a function of the traffic management indication to the vehicle which travels on the traffic lane related to the traffic sign.

S402, obtaining the image of the traffic sign corresponding to the image of the first lane according to which traffic lane the first lane is and the relationship established between the traffic lanes and the traffic signs.

Where, the first lane is the traffic lane where the vehicle current travels on. The traffic sign related to the traffic lane where the vehicle current travels on has the function of traffic management indication on the first lane. Thus, following, the method can perform the S104, outputting the control signal to the driving system of the vehicle according to content of the image of the traffic sign corresponding to the first lane.

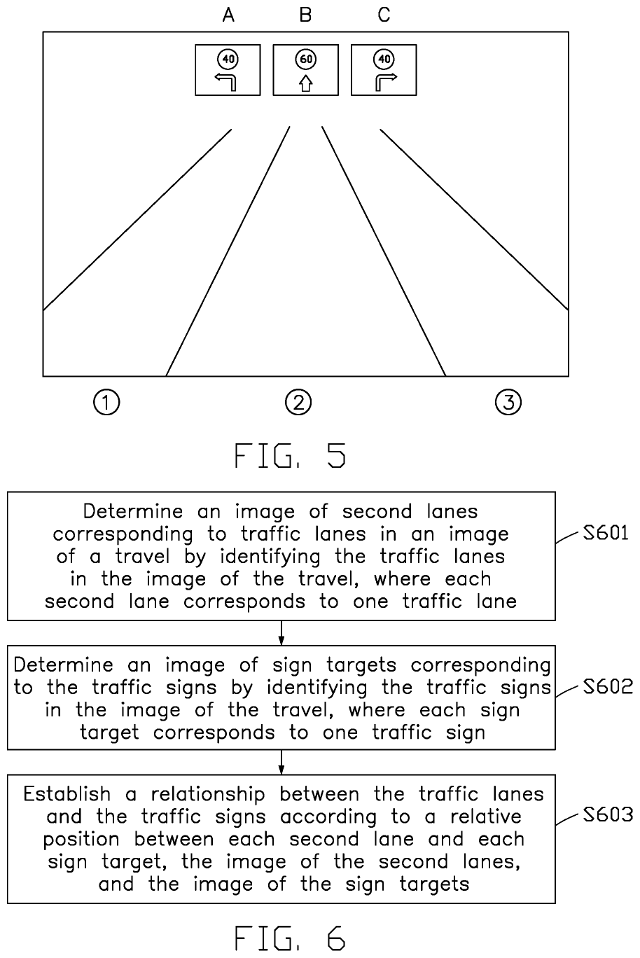

Referring to FIGS. 5-6, in some embodiments, S401, establishing the relationship between the traffic lanes and the traffic signs by identifying the traffic lanes and the traffic signs in the image of the travel, includes:

S601, determining an image of second lanes corresponding to the traffic lanes in the image of the travel by identifying the traffic lanes in the image of the travel, where each second lane corresponds to one traffic lane.

Where, after identifying all the traffic lanes in the road in the image of the travel, the method marks each traffic lane in the sequence via the lane index in the image of the travel, to determine the image of the second lanes corresponding to all the identified traffic lanes.

For example, when the vehicle travels on a single lane road, the driving recorder can capture a traffic lane, thus the image of the travel includes a second lane. When the vehicle travels on a three-lane road, the driving recorder can capture three traffic lanes, thus the image of the travel includes three second lanes.

S602, determining an image of sign targets corresponding to the traffic signs by identifying the traffic signs in the image of the travel, where each sign target corresponds to one traffic sign.

Where, all the identified traffic signs can be recorded via the sign targets. Each traffic sign corresponds to one sign target.

S603, establishing the relationship between the traffic lanes and the traffic signs according to a relative position between each second lane and each sign target, the image of the second lanes, and the image of the sign targets.

Where, in the road that each second lane corresponds to one sign target, there is a relationship between the position of each sign target and the position of each second lane. For example, each sign target is erected above a corresponding second lane. Thus, in the image of the travel, the position of each traffic sign should be closed to the position of a corresponding traffic lane.

The method analyzes the relative position between each second lane and each sign target in the image of the travel, to establish the relationship between the traffic lanes and the traffic signs.

In some embodiments, S603 in detail includes, 1) determining a distance between each second lane and each sign target in the image of the travel; and 2) determining that the sign target associated with the second lane is the sign target closest to the second lane in the image of the travel, to establish the relationship between the traffic lanes and the traffic signs.

In some embodiments, establishing the relationship between the traffic lanes and the traffic signs in detail includes, 1) giving different sign types to different sign targets in the image of the travel; and 2) associating the sign type of each sign target with the lane index of the corresponding second lane in the image of the travel. Thus, the sign target corresponds to the second lane associated with the sign target.

In an example road, in the image of the travel, the captured road includes three traffic lanes. In the image of the travel, a traffic sign plate is erected above each traffic lane, and there are descriptions related to the direction of the travel of the lane and the speed limit in the traffic sign plate.

Thus, via the S601-S603, three second lanes can be obtained according to three traffic lanes, the lane indexes of three second lanes are respective \textcircled{1}, \textcircled{2}, and \textcircled{3}. And three sign targets can be obtained according to three traffic sign plates, the three sign targets are respective a sign target A, a sign target B, and a sign target C.

Where, a sign content of the sign target A is that the direction of the travel of the lane is left-turn and the speed limit of the lane is 40 km/h. A sign content of the sign target B is that the direction of the travel of the lane is going straight and the speed limit of the lane is 60 km/h. A sign content of the sign target C is that the direction of the travel of the lane is right-turn and the speed limit of the lane is 40 km/h.

Thus, analyzing the relative position between each second lane and each sign target, to establish the relationship between the traffic lanes and the traffic signs can be that, for example, in the image of the travel, the second lane having the lane index \textcircled{1} is associated with the sign target A, the second lane having the lane index \textcircled{2} is associated with the sign target B, and the second lane having the lane index \textcircled{3} is associated with the sign target C.

In the S103, if the lane index of the first lane is \textcircled{1}, the traffic sign corresponding to the first lane is the sign target A in the image of the travel. If the lane index of the first lane is \textcircled{2}, the traffic sign corresponding to the first lane is the sign target B in the image of the travel. If the lane index of the first lane is \textcircled{3}, the traffic sign corresponding to the first lane is the sign target C in the image of the travel.

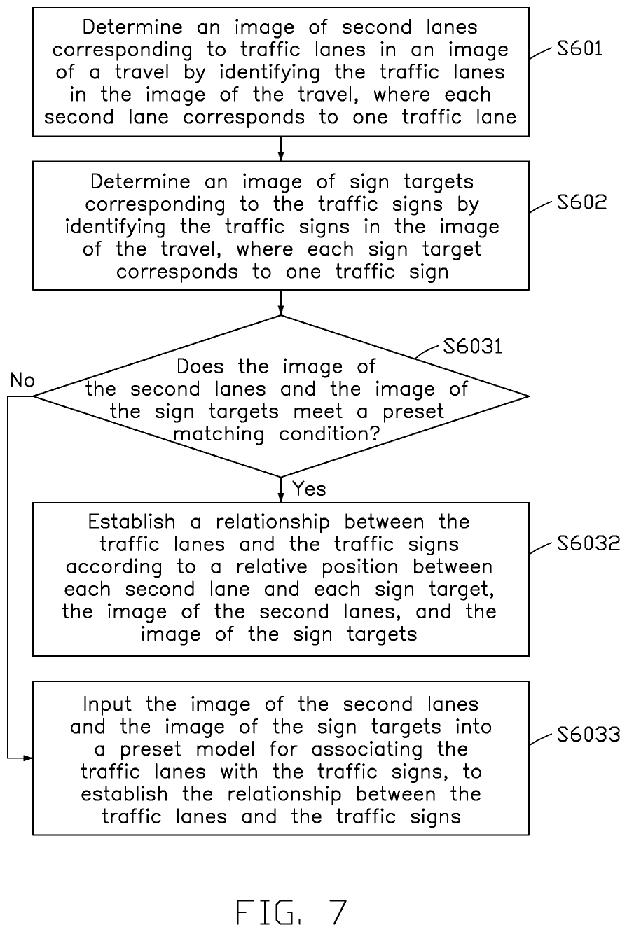

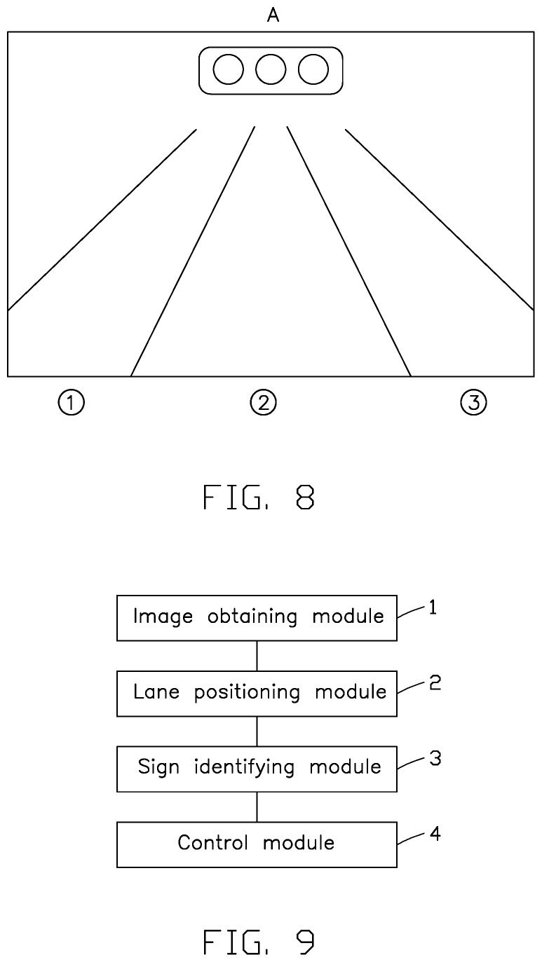

Referring to FIGS. 7-8, in some embodiments, S401, establishing the relationship between the traffic lanes and the traffic signs by identifying the traffic lanes and the traffic signs in the image of the travel, can include:

S601, determining an image of second lanes corresponding to the traffic lanes in the image of the travel by identifying the traffic lanes in the image of the travel, where each second lane corresponds to one traffic lane.

A detail of the S601 can refer to the aforementioned related description, which will not be described herein.

S602, determining an image of sign targets corresponding to the traffic signs by identifying the traffic signs in the image of the travel, where each sign target corresponds to one traffic sign.

A detail of the S602 can refer to the aforementioned related description, which will not be described herein.

S6031, determining whether the image of the second lanes and the image of the sign targets meet a preset matching condition.

Where, the preset matching condition can be that the position of each traffic lane in the road in the image of the travel corresponds to one traffic sign. If the image of the second lanes and the image of the sign targets meet the preset matching condition, the procedure goes to S6032. If the image of the second lanes and the image of the sign targets do not meet the preset matching condition, the procedure goes to S6033.

It can be understood that, the matching condition can be that a first number of the second lanes is the same as a second number of the sign targets. If the first number of the second lanes is the same as the second number of the sign targets, there is a one-to-one relationship between the traffic signs of the current road and the traffic lanes, thus the relationship can be established by using the relative position between the traffic signs and the traffic lanes.

S6032, establishing the relationship between the traffic lanes and the traffic signs according to the relative position between each second lane and each sign target, the image of the second lanes, and the image of the sign targets.

A detail of the S6032 can refer to the related description of the S603, which will not be described herein.

S6033, inputting the image of the second lanes and the image of the sign targets into a preset model for associating the traffic lanes with the traffic signs, to establish the relationship between the traffic lanes and the traffic signs.

In some embodiments, if the image of the second lanes and the image of the sign targets do not meet the preset matching condition, there is not a one-to-one relationship between the traffic signs of the current road and the traffic lanes, thus the relative position between the traffic signs and the traffic lanes cannot be used to establish the relationship.

Where, the model for associating the traffic lanes with the traffic signs can be a neural network model established based on the relationship between the traffic lanes and the traffic signs.

In some embodiments, a training dataset of the model for associating the traffic lanes with the traffic signs includes a number of training images and label information. The training images are the images including the traffic lanes and the traffic signs. A shooting viewing angle of the training images is similar to a shooting view angle of the image of the travel. Each training image corresponds to the label information. The label information labels each traffic lane and each traffic sign in each training image, and a relationship between each traffic lane and each traffic sign in each training image.

In an example road, in the image of the travel, the captured road includes three traffic lanes. In the image of the travel, a traffic light is erected above the road. At the moment, the traffic light is a red light. Three traffic lanes can be a left-turn lane, a going straight lane, and a right-turn lane in the arrangement sequence from left to right, and the vehicle travelling in the right-turn lane can go a right-turn when the traffic light is the red light.

Thus, via the S601-S603, three second lanes can be obtained according to three traffic lanes, the lane indexes of three second lanes are respective \textcircled{1}, \textcircled{2}, and \textcircled{3}. And, the sign target A can be obtained according to the traffic light, and the sign content of the sign target A can be rejecting of the further travel onward.

The relationship established by using the model for associating the traffic lanes with the traffic signs can be, for example, in the image of the travel, the second lane having the lane index \textcircled{1} and the lane index \textcircled{2} being associated with the sign target A.

In the S104, in the image of the travel, if the lane index of the first lane is \textcircled{1} or \textcircled{2}, the traffic sign corresponding to the first lane is the sign target A. In the image of the travel, if the lane index of the first lane is \textcircled{3}, there is no traffic sign corresponding to the first lane existed in the image of the travel, and the procedure goes to the end.

The implementation principle of the method according to the embodiment of the present disclosure is described below. The method can obtain the image of the first lane and the image of the traffic sign corresponding to the image of the first lane by identifying the traffic lanes and the traffic signs in the image of the travel after obtaining the image of the travel, and output the control signal to the driving system of the vehicle according to content of the image of the traffic sign corresponding to the image of the first lane. Thus, in a condition of an expansive and a complex traffic signs erected above the traffic road, the method can accurately detect the traffic sign suitable for the current travel state of the vehicle from the traffic signs. An interference of complex traffic signs to a driving of the vehicle is reduced, thus an accuracy prompt to a driver or an accuracy control of a travel of the vehicle according to the traffic signs can be achieved.

Referring to FIG. 9, FIG. 9 is a view of an embodiment of a system of identifying traffic signs. The system can include a number of function modules consisting of program code segments. The system can be divided into a number of functional modules, according to the performed functions. The functional modules can include an image obtaining module 1, a lane positioning module 2, a sign identifying module 3, and a control module 4. The functions of each module will be detailed in the following embodiments.

The image obtaining module 1 is configured to obtain an image of a travel in front of vehicle when the vehicle is moving forward, wherein the image of the travel includes the traffic lanes and the traffic signs.

The lane positioning module 2 is configured to process the image of the travel to obtain an image of a first lane where the vehicle is in.

The sign identifying module 3 is configured to obtain an image of a traffic sign correspond to the image of the first lane from the image of the travel according to the image of the first lane.

The control module 4 is configured to output a control signal to a driving system of the vehicle according to content of the image of the traffic sign corresponding to the image of the first lane.

Due to a function of each block and logical connections between individual aspect blocks themselves, the system provided in the disclosure can achieve the steps of the aforementioned method, and achieve a technical effect the same as the aforementioned method.

The principle analysis can refer to a related description of the step of the aforementioned method, and is not described herein.

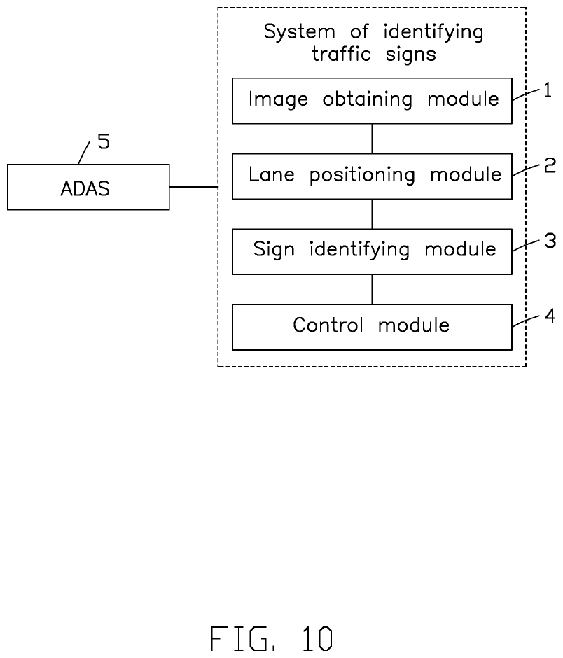

Referring to FIG. 10, FIG. 10 is a block diagram of an embodiment of a vehicle. The vehicle includes a ADAS (Advanced Driving Assistance System) 5 and a system of identifying traffic signs. The ADAS 5 is a driving system of the vehicle. The ADAS 5 is configured to receive the one or more control signals, and control a travel of the vehicle according to the one or more control signals.

In detail, the ADAS 5 can obtain information of the travel state of the vehicle, and control the travel of the vehicle according to the information of the travel state and the one or more control signals.

Where, the information of the travel state is configured to reflect a current state of the travel of the vehicle, a speed of the travel, a direction of the travel, a current lane of the travel, a position of the vehicle, and a planned path. Where, the current state of the travel of the vehicle is the first lane where the vehicle is in. The position of the vehicle can be a current position of the vehicle. The position of the vehicle can be obtained via a navigation position module arranged on the vehicle. The planned path is a preset path of the travel of the vehicle, the vehicle should travel along the preset path of the travel.

Via comparing the information of the travel state of the vehicle with the control signal outputted by the system, whether the current travel state of the vehicle meets a standard of the traffic management indicated by the traffic sign can be analyzed, and the travel state of the vehicle can be accordingly adjusted.

It can be understood that, the traffic sign can be one or more of a group consisting of the speed limit sign, the direction sign of the travel of the lane, and the traffic light.

In an application example, when the control signal includes the control signal of the speed limit, and the control signal of the speed limit is speed limit of the lane 40 km/h, the vehicle can analyze whether a current speed of the travel of the vehicle is greater than 40 km/h according to the information of the travel state of the vehicle. If the current speed of the travel of the vehicle is greater than 40 km/h, the vehicle adjusts the current speed of the travel of the vehicle until the current speed of the travel of the vehicle is less than or equal to 40 km/h.

When the control signal includes the control signal of the direction of the travel. The control signal of the direction of the travel indicates the direction of the travel in the current traffic lane, the vehicle can analyze the planned direction of the travel of the vehicle according to the position of the vehicle and the planned path, to determine whether the vehicle needs to change the lane. If the vehicle needs to change the lane, the vehicle adjusts the current direction of the travel of the vehicle until the vehicle moves to an appropriate traffic lane.

When the control signal includes the passage control signal, and the passage control signal is the control signal of rejecting of a further travel onward, the vehicle can determine whether a brake is needed according to a speed of a travel of the vehicle. If the brake is needed, the vehicle brakes.

Due to a function of each block and logical connections between individual aspect blocks themselves, the vehicle provided in the disclosure can achieve the steps of the aforementioned method, and achieve a technical effect the same as the aforementioned method. The principle analysis can refer to a related description of the step of the aforementioned method, and is not described herein.

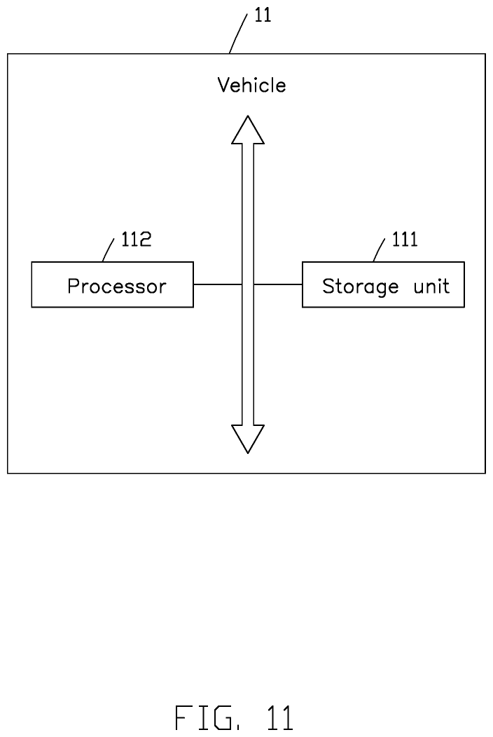

Referring to FIG. 11, FIG. 11 is a block diagram of another embodiment of a vehicle.

The vehicle 11 can include a storage unit 111, at least one processor 112, and one or more programs 113 stored in the storage unit 111 and can be run on the at least one processor 112. The at least one processor 112 can execute the one or more programs 113 to accomplish the steps of the exemplary method.

The one or more programs 113 can be divided into one or more modules/units. The one or more modules/units can be stored in the storage unit 111 and executed by the at least one processor 112 to accomplish the object of the present disclosure. The one or more modules/units can be a series of program instruction segments which can perform specific functions, and the instruction segment is configured to describe the execution process of the one or more programs 113 in the vehicle 11.

A person skilled in the art knows that the vehicle in FIG. 11 is only an example, and does not be considered as limiting of the vehicle 11, the vehicle 11 may include more or fewer parts than the diagram, or combine of certain parts, or includes different parts.

The at least one processor 112 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 112 can be a microprocessor or the at least one processor 112 can be any regular processor, or the like. The at least one processor 112 can be a control center of the vehicle 11, using a variety of interfaces and lines to connect various parts of the entire vehicle 11.

The storage unit 111 stores the one or more programs and/or modules/units. The at least one processor 112 can run or execute the one or more programs and/or modules/units stored in the storage unit 111, call out the data stored in the storage unit 111, and accomplish the various functions of the vehicle 11, for example apply the methods hereinbefore described. The storage unit 111 may include a program area and a data area. The program area can store an operating system, and applications that are required for the at least one function, such as sound playback features, images playback functions, and so on. The data area can store data created according to the use of the vehicle 11, such as video data, audio data, and so on. In addition, the storage unit 111 can include high-speed random access memory and non-transitory storage medium, such as hard disk, memory, plug-in hard disk, smart media card, secure digital, flash card, at least one disk storage device, flash memory, or other transitory storage medium.

If the integrated module/unit of the vehicle 11 is implemented in the form of or by means of a software functional unit and is an independent product sold or used, all parts of the integrated module/unit of the vehicle 11 may be stored in a computer-readable storage medium. The vehicle 11 can use one or more programs to control the related hardware to accomplish all parts of the methods of this disclosure. The one or more programs can be stored in a computer-readable storage medium. The one or more programs can be accomplish the block of the exemplary method when executing by the at least one processor. The one or more stored programs can include program code. The program code can be in the form of source code, object code, executable code file, or in some intermediate form. The computer-readable storage medium may include any entity or device capable of recording and carrying the program codes, recording media, USB flash disk, mobile hard disk, disk, computer-readable storage medium, read-only memory, Random access memory, electrical carrier signals, telecommunications signals, and software distribution package. The content stored in the computer-readable storage medium can be increased or decreased in accordance with legislative requirements and regulations of patent practice jurisdictions, for example, in some jurisdictions, legislation and patent practice stipulates that computer-readable storage medium does not include electrical carrier signals or telecommunications signals.

The disclosure further provides a computer readable storage medium configured to store one or more programs. The processor can execute the one or more programs to accomplish the steps of the exemplary method.

A computer readable storage medium may be any medium capable of storing one or more programs, for example, but not limited to, a USB flash disk, a movable hard disk, a read-only memory (ROM), a random access memory (RAM), a Disc, or a disk, and so on.

One or more programs are stored in the computer readable storage medium and one or more programs which when executed by the at least one processor, cause the at least one processor to perform the steps of the aforementioned steps. Thus, the computer readable storage medium can achieve a technical effect the same as the aforementioned method. The principle analysis can refer to a related description of the step of the aforementioned method, and is not described herein.

It should be noted that the embodiments mentioned above are only used to illustrate the technical solutions of the present disclosure but not to limit the technical solutions. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

A person having ordinary skill in the art can appreciate that the above embodiments are only examples of the present disclosure, and do not limit the scope of the present disclosure. Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method of identifying traffic signs comprising:
obtaining an image of a travel in front of vehicle when the vehicle is moving forward, wherein the image of the travel comprises one or more traffic lanes and one or more traffic signs;
processing the image of the travel to obtain an image of a first lane where the vehicle is in;
obtaining an image of a traffic sign corresponding to the image of the first lane from the image of the travel according to the image of the first lane; and
outputting one or more control signals to a driving system of the vehicle according to content of the image of the traffic sign corresponding to the image of the first lane.

2. The method according to claim 1, wherein the obtaining the image of the traffic sign corresponding to the image of the first lane from the image of the travel according to the image of the first lane comprises:
establishing a relationship between the traffic lanes and the traffic signs by identifying the traffic lanes and the traffic signs in the image of the travel;
obtaining the image of the traffic sign corresponding to the image of the first lane according to the relationship established between the traffic lanes and the traffic signs.

3. The method according to claim 2, wherein the establishing the relationship between the traffic lanes and the traffic signs by identifying the traffic lanes and the traffic signs in the image of the travel comprises:
determining an image of one or more second lanes corresponding to the one or more traffic lanes in the image of the travel by identifying the traffic lanes in the image of the travel; where each of the second lanes corresponds to one of the traffic lanes;
determining an image of one or more sign targets corresponding to the one or more traffic signs by identifying the traffic signs in the image of the travel; where each of the sign targets corresponds to one of the traffic signs;
establishing the relationship between the traffic lanes and the traffic signs according to a relative position between each of the second lanes and each of the sign targets, the image of the second lanes, and the image of the sign targets.

4. The method according to claim 2, wherein the establishing the relationship between the traffic lanes and the traffic signs by identifying the traffic lanes and the traffic signs in the image of the travel comprises:
determining an image of one or more second lanes corresponding to the one or more traffic lanes in the image of the travel by identifying the traffic lanes in the image of the travel; where each of the second lanes corresponds to one of the traffic lanes;
determining an image of one or more sign targets corresponding to the one or more traffic signs by identifying the traffic signs in the image of the travel; where each of the sign targets corresponds to one of the traffic signs;
inputting the image of the second lanes and the image of the sign targets into a preset model for associating the traffic lanes with the traffic signs to establish the relationship between the traffic lanes and the traffic signs if the image of the second lanes and the image of the sign targets do not meet a preset matching condition.

5. The method according to claim 4, wherein:
the image of the second lanes and the image of the sign targets meet the preset matching condition if a first number of the second lanes is the same as a second number of the sign targets.

6. The method according to claim 1, wherein the processing the image of the travel to obtain the image of the first lane where the vehicle is in comprises:
identifying a position of a main lane and positions of a plurality of lane lines in the image of the travel;
determining the image of the first lane according to a relative position between the position of the main lane and the positions of each of the plurality of lane lines.

7. The method according to claim 6, wherein before the identifying the position of the main lane and the positions of the plurality of lane lines in the image of the travel, the method further comprises:
performing a perspective processing on the image of the travel, to obtain the image of the travel in a bird's eye perspective.

8. A vehicle comprising:
a storage device;
at least one processor; and
the storage device storing one or more programs, which when executed by the at least one processor, cause the at least one processor to:
obtain an image of a travel in front of vehicle when the vehicle is moving forward, wherein where the image of the travel comprises one or more traffic lanes and one or more traffic signs;
process the image of the travel to obtain an image of a first lane where the vehicle is in;
obtain an image of a traffic sign corresponding to the image of the first lane from the image of the travel according to the image of the first lane; and
output one or more control signals to a driving system of the vehicle according to content of the image of the traffic sign corresponding to the image of the first lane.

9. The vehicle according to claim 8, wherein further causes the at least one processor to:
establish a relationship between the traffic lanes and the traffic signs by identifying the traffic lanes and the traffic signs in the image of the travel;
obtain the image of the traffic sign corresponding to the image of the first lane according to the relationship established between the traffic lanes and the traffic signs.

10. The vehicle according to claim 9, wherein further causes the at least one processor to:
determine an image of one or more second lanes corresponding to the one or more traffic lanes in the image of the travel by identifying the traffic lanes in the image of the travel; where each of the second lanes corresponds to one of the traffic lanes;
determine an image of one or more sign targets corresponding to the one or more traffic signs by identifying the traffic signs in the image of the travel; where each of the sign targets corresponds to one of the traffic signs;
establish the relationship between the traffic lanes and the traffic signs according to a relative position between each of the second lanes and each of the sign targets, the image of the second lanes, and the image of the sign targets.

11. The vehicle according to claim 9, wherein further causes the at least one processor to:
determine an image of one or more second lanes corresponding to the one or more traffic lanes in the image of the travel by identifying the traffic lanes in the image of the travel; where each of the second lanes corresponds to one of the traffic lanes;
determine an image of one or more sign targets corresponding to the one or more traffic signs by identifying the traffic signs in the image of the travel; where each of the sign targets corresponds to one of the traffic signs;
input the image of the second lanes and the image of the sign targets into a preset model for associating the traffic lanes with the traffic signs to establish the relationship between the traffic lanes and the traffic signs if the image of the second lanes and the image of the sign targets do not meet a preset matching condition.

12. The vehicle according to claim 11, wherein:
the image of the second lanes and the image of the sign targets meet the preset matching condition if a first number of the second lanes is the same as a second number of the sign targets.

13. The vehicle according to claim 8, wherein further causes the at least one processor to:
identify a position of a main lane and positions of a plurality of lane lines in the image of the travel;
determine the image of the first lane according to a relative position between the position of the main lane and the positions of each of the plurality of lane lines.

14. The vehicle according to claim 13, wherein further causes the at least one processor to:
performing a perspective processing on the image of the travel, to obtain the image of the travel in a bird's eye perspective.

15. A non-transitory storage medium storing a set of commands, when the commands being executed by at least one processor of a vehicle, causing the at least one processor to:
obtain an image of a travel in front of vehicle when the vehicle is moving forward, wherein where the image of the travel comprises one or more traffic lanes and one or more traffic signs;
process the image of the travel to obtain an image of a first lane where the vehicle is in;
obtain an image of a traffic sign corresponding to the image of the first lane from the image of the travel according to the image of the first lane; and
output one or more control signals to a driving system of the vehicle according to content of the image of the traffic sign corresponding to the image of the first lane.

16. The non-transitory storage medium according to claim 15, wherein further causes the at least one processor to:
establish a relationship between the traffic lanes and the traffic signs by identifying the traffic lanes and the traffic signs in the image of the travel;
obtain the image of the traffic sign corresponding to the image of the first lane according to the relationship established between the traffic lanes and the traffic signs.

17. The non-transitory storage medium according to claim 16, wherein further causes the at least one processor to:
determine an image of one or more second lanes corresponding to the one or more traffic lanes in the image of the travel by identifying the traffic lanes in the image of the travel; where each of the second lanes corresponds to one of the traffic lanes;
determine an image of one or more sign targets corresponding to the one or more traffic signs by identifying the traffic signs in the image of the travel; where each of the sign targets corresponds to one of the traffic signs;
establish the relationship between the traffic lanes and the traffic signs according to a relative position between each of the second lanes and each of the sign targets, the image of the second lanes, and the image of the sign targets.

18. The non-transitory storage medium according to claim 16, wherein further causes the at least one processor to:
determine an image of one or more second lanes corresponding to the one or more traffic lanes in the image of the travel by identifying the traffic lanes in the image of the travel; where each of the second lanes corresponds to one of the traffic lanes;
determine an image of one or more sign targets corresponding to the one or more traffic signs by identifying the traffic signs in the image of the travel; where each of the sign targets corresponds to one of the traffic signs;
input the image of the second lanes and the image of the sign targets into a preset model for associating the traffic lanes with the traffic signs to establish the relationship between the traffic lanes and the traffic signs if the image of the second lanes and the image of the sign targets do not meet a preset matching condition.

19. The non-transitory storage medium according to claim 18, wherein:
the image of the second lanes and the image of the sign targets meet the preset matching condition if a first number of the second lanes is the same as a second number of the sign targets.

20. The non-transitory storage medium according to claim 15, wherein further causes the at least one processor to:
identify a position of a main lane and positions of a plurality of lane lines in the image of the travel;
determine the image of the first lane according to a relative position between the position of the main lane and the positions of each of the plurality of lane lines.
